(19) United States
(12) Patent Application Publication
(10) Pub. No.: US 2026/0213206 A1
(43) Pub. Date: Jul. 23, 2026

(54) NEGATIVE ELECTRODE FOR SECONDARY BATTERIES, AND SECONDARY BATTERY

(71) Applicant: Panasonic Energy Co., Ltd., Moriguchi-shi, Osaka (JP)

(72) Inventor: Yoko Uraki, Osaka (JP)

(73) Assignee: Panasonic Energy Co., Ltd., Moriguchi-shi, Osaka (JP)

(21) Appl. No.: 19/140,717

(22) PCT Filed: Dec. 5, 2023
(86) PCT No.: PCT/JP2023/043373

§ 371 Date: Jun. 18, 2025

(30) Foreign Application Priority Data
Dec. 27, 2022 (JP) 2022-210578

(51) Int. Cl. H01M 4/62; H01M 4/02; H01M 4/134; H01M 4/38; H01M 10/052

(52) U.S. Cl. CPC H01M 4/625; H01M 4/134; H01M 4/386; H01M 10/052; H01M 2004/021; H01M 2004/027

(57) ABSTRACT

Provided is a negative electrode for secondary batteries, the negative electrode being capable of suppressing decrease in the charge/discharge cycle characteristics of a battery. A negative electrode for secondary batteries according to one aspect of the present disclosure is provided with: a negative electrode current collector; and a negative electrode mixture layer formed on the surface of the negative electrode current collector. The negative electrode mixture layer contains carbon nanotubes and a compound of a Si-containing material and a silane coupling agent. The silane coupling agent has a phenyl group and at least one of an amine group and a methyl group.

### TECHNICAL FIELD

The present disclosure relates to a negative electrode for a secondary battery and a secondary battery.

### BACKGROUND ART

Although a carbon-based material is generally used for a negative electrode for a secondary battery such as a non-aqueous electrolyte secondary battery, the use of a Si-containing material for the negative electrode has been studied to increase the capacity of the battery.

For example, Patent Literatures 1 to 3 each disclose a negative electrode for a secondary battery including a negative electrode active material of a Si-containing material and carbon nanotubes having a functional group such as a carboxyl group (Patent Literatures 2 to 4).

### CITATION LIST

### Patent Literature

PATENT LITERATURE 1: Japanese Unexamined Patent Application Publication No. 2021-176140
PATENT LITERATURE 2: Japanese Unexamined Patent Application Publication No. 2007-242386
PATENT LITERATURE 3: Japanese Translation of PCT International Application Publication No. 2009-507338

### SUMMARY

Since a Si-containing material has a large volume change (expansion and contraction) during charge and discharge, there is a problem that a conductive path of a negative electrode mixture layer including the Si-containing material is disconnected due to the large volume change of the Si-containing material in the case of repeated charge and discharge, which tends to deteriorate charge-discharge cycle characteristics.

Accordingly, an object of the present disclosure is to provide a negative electrode for a secondary battery capable of suppressing deterioration of charge-discharge cycle characteristics of the battery, and a secondary battery comprising the negative electrode for the secondary battery.

A negative electrode for a secondary battery according to an aspect of the present disclosure comprises a negative electrode current collector and a negative electrode mixture layer formed on a surface of the negative electrode current collector, wherein the negative electrode mixture layer contains a compound of a Si-containing material and a silane coupling agent, and carbon nanotubes, and the silane coupling agent has at least one of an amine group and a methyl group, and a phenyl group.

A secondary battery according to an aspect of the present disclosure comprises the negative electrode for a secondary battery.

According to the present disclosure, it is possible to provide a negative electrode for a secondary battery capable of suppressing deterioration of charge-discharge cycle characteristics of the battery, and a secondary battery comprising the negative electrode for the secondary battery.

### BRIEF DESCRIPTION OF DRAWINGS

FIG. 1 is a longitudinal sectional view of a secondary battery of an example of an embodiment.

FIG. 2 is a view schematically illustrating the constitution of a compound of a Si-containing material and a silane coupling agent and a carbon nanotube according to an example of embodiments.

### DESCRIPTION OF EMBODIMENTS

Hereinafter, an example of embodiments will be described in detail. The drawings referred to in the description of embodiments are schematically illustrated, and dimensional ratios and the like of components drawn in the drawings may be different from the actual product.

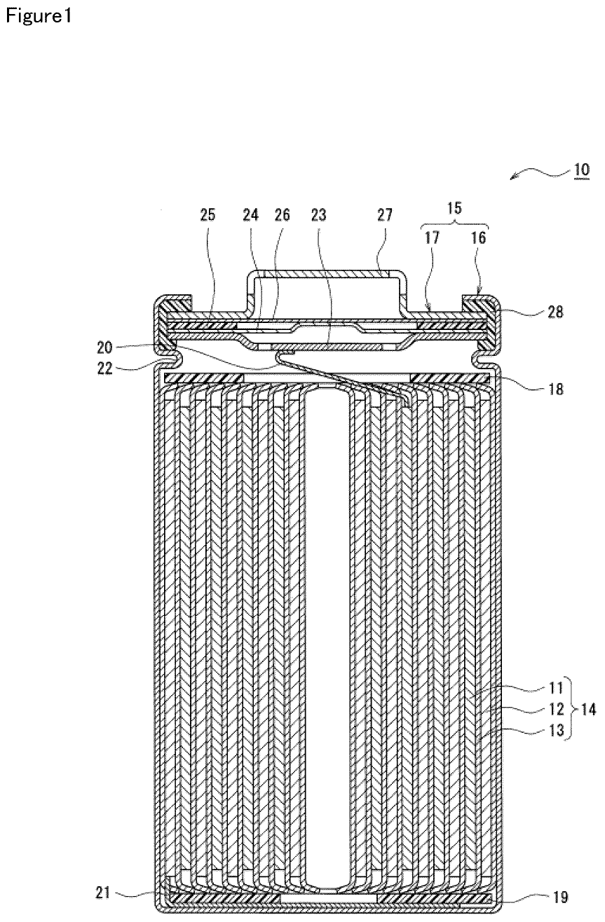

FIG. 1 is a longitudinal sectional view of a secondary battery of an example of an embodiment. A secondary battery 10 illustrated in FIG. 1 comprises a wound electrode assembly 14 formed by winding a positive electrode 11 and a negative electrode 12 through a separator 13, a non-aqueous electrolyte, insulating plates 18 and 19 disposed on the upper and lower sides of the electrode assembly 14, and a battery case 15 that houses the above-described members. The battery case 15 is composed of a bottomed cylindrical case body 16 and a sealing assembly 17 that closes an opening portion of the case body 16. Instead of the wound electrode assembly 14, another type of an electrode assembly may be used, such as stacked electrode assembly in which the positive electrode and the negative electrode are alternately laminated through a separator. Examples of the battery case 15 include a metal case having a cylindrical shape, a rectangular shape, a coin shape, a button shape, or the like, and a resin case formed by laminating resin sheets (so-called laminate case).

The non-aqueous electrolyte has lithium-ion conductivity. The non-aqueous electrolyte may be a liquid electrolyte (an electrolyte liquid) or may be a solid electrolyte.

The liquid electrolyte (the electrolyte liquid) includes a non-aqueous solvent and an electrolyte salt dissolved in the non-aqueous solvent. For the non-aqueous solvent, esters, ethers, nitriles, amides, and a mixed solvent of greater than or equal to two thereof, and the like are used, for example. An example of the non-aqueous solvent is ethylene carbonate (EC), ethyl methyl carbonate (EMC), dimethyl carbonate (DMC), diethyl carbonate (DEC), a mixed solvent thereof, or the like. The non-aqueous solvent may contain a halogen-substituted derivative in which hydrogen of these solvents is at least partially replaced with a halogen atom such as fluorine (for example, fluoroethylene carbonate or the like). For the electrolyte salt, a lithium salt such as LiPF₆ is used, for example.

As the solid electrolyte, a solid or gel polymer electrolyte, an inorganic solid electrolyte, and the like may be used, for example. For the inorganic solid electrolyte, a known material for an all-solid lithium-ion secondary battery or the like (for example, an oxide-type solid electrolyte, a sulfide-type solid electrolyte, a halogen-type solid electrolyte, and the like) may be used. The polymer electrolyte includes a lithium salt and a matrix polymer, or includes the non-aqueous solvent, the lithium salt, and a matrix polymer, for example. As the matrix polymer, a polymer material that absorbs the non-aqueous solvent to gel is used, for example. Examples of the polymer material include a fluororesin, an acrylic resin, and a polyether resin.

The case body 16 is, for example, a bottomed cylindrical metallic container. A gasket 28 is provided between the case body 16 and the sealing assembly 17 to achieve sealability inside the battery. The case body 16 has a projecting portion 22 in which a part of a side wall thereof projects inward to support the sealing assembly 17, for example. The projecting portion 22 is preferably formed in a circular shape along a circumferential direction of the case body 16, and supports the sealing assembly 17 with the upper face thereof.

The sealing assembly 17 has a stacked structure of a filter 23, a lower vent member 24, an insulating member 25, an upper vent member 26, and the cap 27 in this order from the electrode assembly 14 side. Each member constituting the sealing assembly 17 has, for example, a disk shape or a ring shape, and each member except for the insulating member 25 is electrically connected to each other. The lower vent member 24 and the upper vent member 26 are connected to each other at each of central parts thereof, and the insulating member 25 is interposed between the circumferential parts of the lower vent member 24 and the upper vent member 26. If the internal pressure of secondary battery 10 increases due to heat generation caused by an internal short circuit or the like, for example, the lower vent member 24 is deformed so as to push the upper vent member 26 up toward the cap 27 side and breaks, and a current pathway between the lower vent member 24 and the upper vent member 26 is cut off. If the internal pressure further increases, the upper vent member 26 breaks, and gas is discharged through an opening portion of the cap 27.

In the secondary battery 10 illustrated in FIG. 1, the positive electrode lead 20 attached to the positive electrode 11 extends through a through hole of the insulating plate 18 toward the sealing assembly 17 side, and the negative electrode lead 21 attached to the negative electrode 12 extends through the outside of the insulating plate 19 toward the bottom of the case body 16. The positive electrode lead 20 is connected to a lower surface of a filter 23, which is a bottom plate of the sealing assembly 17 by welding or the like, and a cap 27, which is a top plate of the sealing assembly 17 electrically connected to the filter 23, becomes a positive electrode terminal. The negative electrode lead 21 is connected to a bottom inner surface of the case body 16 by welding or the like, and the case body 16 becomes a negative electrode terminal.

Hereinafter, the positive electrode 11, the negative electrode 12, and the separator 13 will be described in detail.

[Positive Electrode]

The positive electrode 11 comprise a positive electrode current collector and a positive electrode mixture layer formed on a surface of the positive electrode current collector. For the positive electrode current collector, a foil of a metal stable within a potential range of the positive electrode, such as aluminum and an aluminum alloy, a film in which such a metal is disposed on a surface layer thereof, and the like may be used. The positive electrode mixture layer is composed of, for example, a positive electrode active material, a binder, and a conductive agent. The positive electrode mixture layer is preferably formed on both surfaces of the positive electrode current collector. The positive electrode 11 may be manufactured by, for example, applying a positive electrode mixture slurry including the positive electrode active material, the binder, the conductive agent, and the like to the positive electrode current collector, and drying and rolling the coating film to form the positive electrode mixture layer on the surface of the positive electrode current collector.

The positive electrode active material is, for example, a lithium complex oxide capable of reversibly inserting and removing lithium. Examples of metal elements contained in the lithium complex oxide include Ni, Co, Mn, Al, B, Mg, Ti, V, Cr, Fe, Cu, Zn, Ga, Sr, Zr, Nb, In, Sn, Ta, and W, among which at least one of Ni, Co, and Mn is preferably contained. An example of a preferable lithium composite oxide is a composite oxide represented by general formula LiMO₂ (M is Ni and X, X is a metal element other than Ni, and the proportion of Ni is greater than or equal to 50 mol % and less than or equal to 95 mol % relative to the total number of moles of metal elements other than Li). Examples of X in the above formula include Co, Mn, Al, B, Mg, Ti, V, Cr, Fe, Cu, Zn, Ga, Sr, Zr, Nb, In, Sn, Ta, and W.

Examples of the conductive agent included in the positive electrode mixture layer may include fibrous carbon such as carbon black, acetylene black, Ketjenblack, graphene, and carbon nanotube; and carbon material such as graphite. Examples of the binder included in the positive electrode mixture layer may include fluorine resins such as polytetrafluoroethylene (PTFE) and polyvinylidene fluoride (PVDF), polyacrylonitrile (PAN), polyimide resins, acrylic resins, and polyolefin resins. Styrene-butadiene rubber (SBR), carboxymethyl cellulose (CMC) or a salt thereof, polyacrylic acid (PAA) or a salt thereof (which may be PAA-Na, PAA-K, or a partially neutralized salt), polyethylene oxide (PEO), polyvinyl alcohol (PVA), and the like may be exemplified.

### [Negative Electrode]

The negative electrode 12 comprise a negative electrode current collector and a negative electrode mixture layer formed on a surface of the negative electrode current collector. For the negative electrode current collector, a foil of a metal stable within a potential range of the negative electrode, such as copper and a copper alloy, a film in which such a metal is disposed on a surface layer thereof, and the like may be used.

The negative electrode mixture layer contains a compound of a Si-containing material serving as a negative electrode active material and a silane coupling agent, and carbon nanotubes serving as a conductive material. As described later, when the silane coupling agent has a predetermined structure, a conductive path is secured, thereby suppressing deterioration of the charge-discharge cycle characteristics.

The negative electrode 12 may be manufactured by, for example, applying a negative electrode mixture slurry prepared by mixing the negative electrode active material, the silane coupling agent, the conductive agent, and the like to the negative electrode current collector, and drying and rolling the coating film to form the negative electrode mixture layer on the surface of the negative electrode current collector.

Examples of the Si-containing material serving as the negative electrode active material include Si particles, alloy particles including Si, and composite particles including Si. These may be used singly or in combination of two or more thereof. A conductive layer may be formed on the surface of the Si-containing material. The conductive layer includes, for example, conductive carbon and covers an area of greater than or equal to 30% and less than or equal to 70% of the surface of the Si-containing material. The coverage of the conductive layer can be calculated using, for example, X-ray photoelectron spectroscopy (XPS).

The Si particles are generally obtained by a vapor phase method, pulverization of silicon chips, or the like but may be manufactured by any method. Examples of the alloy particles including Si include alloys of Si and a metal selected from the group consisting of an alkali metal, an alkaline earth metal, a transition metal, a rare earth metal, and a combination thereof.

The composite particles including Si include, for example, a lithium ion conductive phase and Si particles dispersed in the lithium ion conductive phase. The lithium ion conductive phase is, for example, at least one selected from the group consisting of a silicon oxide phase, a silicate phase, and a carbon phase.

The silicate phase preferably includes at least one element selected from the group consisting of lithium, sodium, potassium, rubidium, cesium, francium, beryllium, magnesium, calcium, strontium, barium, and radium from the viewpoint of, for example, high lithium ion conductivity, among which the silicate phase is preferably a silicate phase including lithium (hereinafter, sometimes referred to as a lithium silicate phase) from the viewpoint of high lithium ion conductivity.

The lithium silicate phase is represented by, for example, the formula Li_{2z}SiO_{2+z} (0<z<2). From the viewpoint of stability, ease of production, lithium ion conductivity, and the like, z preferably satisfies the relationship of 0<z<1, more preferably z=½.

Composite particles including Si particles dispersed in the silicon oxide phase are represented, for example, by the general formula SiOₓ (preferably in the range of 0<x<2, more preferably in the range of 0.5≤x≤1.6). Composite particles including Si particles dispersed in the carbon phase are represented, for example, by the general formula SiₓC_{y} (preferably in the range of 0<x≤1 and 0<y≤1).

The content of the Si particles forming the composite particles is, for example, in the range of greater than or equal to 30 mass % and less than or equal to 80 mass %, greater than or equal to 35 mass % and less than or equal to 75 mass %, or greater than or equal to 55 mass % and less than or equal to 70 mass %. The content of Si particles may be measured by Si-NMR.

### (Si-NMR Measurement Conditions)

Measuring device: solid-state nuclear magnetic resonance spectrometer (INOVA-400) manufactured by Varian
Probe: Varian 7 mm, CPMAS-2
MAS: 4.2 KHz
MAS speed: 4 kHz
Pulse: DD (45° pulse+signal acquisition time 1H decoupling)
Repetition time: 1200 sec
Observation width: 100 kHz
Observation center: approximately −100 ppm
Signal acquisition time: 0.05 sec
Cumulative number: 560
Sample amount: 207.6 mg

The crystallite size of the Si particles forming the composite particles is, for example, greater than or equal to 10 nm and less than or equal to 30 nm or greater than or equal to 15 nm and less than or equal to 25 nm. The crystallite size of the Si particles is calculated with Scherrer equation from a half-value width of a diffraction peak attributed to a Si(111) face of an X-ray diffraction pattern of the Si particles.

The average particle size of the Si particles forming the composite particles is, for example, greater than or equal to 500 nm before the initial charging, and is, for example, less than or equal to 400 nm after the initial charging. The average particle size of the Si particles is a value obtained by observing a cross section of the composite particles with a scanning electron microscope (SEM) and averaging the maximum diameters of 100 arbitrary Si particles.

The negative electrode active material preferably includes a negative electrode material that exhibits a smaller degree of expansion and contraction during charging and discharging than a Si-containing material. The negative electrode material preferably includes a carbon material capable of reversibly inserting and removing lithium. Examples of the carbon material include graphite, easily graphitizable carbon, and hardly graphitizable carbon, of which graphite having excellent charge-discharge stability and low irreversible capacity is preferable. Graphite is a material having graphite crystals, and examples thereof include natural graphite, artificial graphite, and graphitized mesophase carbon particles.

A content of the Si-containing material is preferably in the range of greater than or equal to 1 mass % and less than or equal to 15 mass % relative to the total mass of the negative electrode active material, from the viewpoint of, for example, increasing the capacity of the battery and suppressing deterioration of the charge-discharge cycle characteristics. A content of the carbon material used as the negative electrode active material is preferably greater than or equal to 85 mass % and less than or equal to 99 mass % relative to the total mass of the negative electrode active material. A content of the negative electrode active material is, for example, greater than or equal to 85 mass %, greater than or equal to 90 mass %, or greater than or equal to 95 mass % relative to the total mass of the negative electrode mixture layer.

The compound of the Si-containing material and the silane coupling agent is formed by covalent bonding between a silanol group included in the silane coupling agent and a hydroxyl group on the surface of the Si-containing material. For example, silanol groups are formed in the silane coupling agent by a reaction with water, and the silanol group and a hydroxyl group on the surface of the Si-containing material undergo a dehydration condensation reaction to form a compound of the Si-containing material and the silane coupling agent. The silanol groups may form a siloxane (Si—O—Si) bond with each other at the same time as the above reaction.

The silane coupling agent has at least one of an amine group and a methyl group, and a phenyl group. A benzene ring derived from the silane coupling agent and a benzene ring of the carbon nanotubes have a π-π interaction, thereby suppressing isolation of the Si-containing material and securing a conductive path. In addition, when the silane coupling agent has at least one of an amine group and a methyl group, as described later, in a case where the carbon nanotube has an acidic functional group, an attractive force may act between the amine group or the methyl group and the acidic functional group, thereby more remarkably suppressing the isolation of the Si-containing material.

The silane coupling agent may be N-phenyl-3-aminopropyltrimethoxysilane represented by general formula I, although it is not particularly limited as long as the silane coupling agent has the above-described characteristics. N-Phenyl-3-aminopropyltrimethoxysilane has an amine group and a phenyl group.

### [Formula 1]

Another example of the silane coupling agent is p-styryltrimethoxysilane represented by general formula II. p-styryltrimethoxysilane has a methyl group and a phenyl group.

### [Formula 2]

The amount of the silane coupling agent added is preferably greater than or equal to 0.01 mass % and less than or equal to 0.8 mass %, more preferably greater than or equal to 0.01 mass % and less than or equal to 0.7 mass %, even more preferably greater than or equal to 0.05 mass % and less than or equal to 0.5 mass %, and particularly preferably greater than or equal to 0.05 mass % and less than or equal to 0.3 mass % relative to the total mass of the negative electrode active material. When the amount of the silane coupling agent added exceeds 0.8 mass %, the viscosity of the negative electrode mixture slurry may become too large to form the negative electrode mixture layer.

Analysis of the content of the coupling agent in the negative electrode mixture layer may be performed by Py-GC/MS.

### (Py-GC/MS Measurement Conditions)

Measuring device: Py-GC/MS (GC unit: GC-2010 manufactured by Shimadzu Corporation, MS unit: GCMS-QP2010 Plus)
Thermal analyzer: PY-2020iD manufactured by Frontier Laboratories Ltd.
Heating furnace temperature: 550° C.
Column: UA-5
Mass range: m/z=5-500
Carrier gas: helium
Sample amount: 25.0 mg

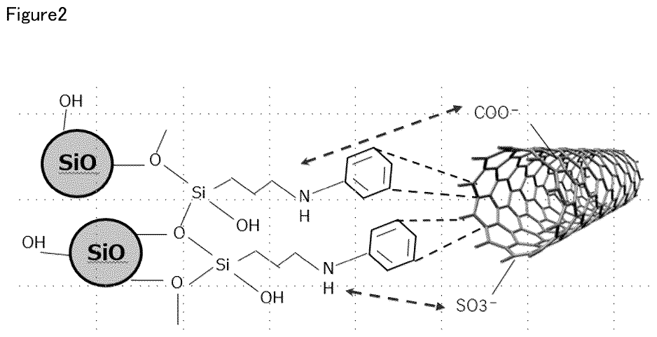

The carbon nanotubes serving as a conductive material preferably has an acidic functional group. FIG. 2 is a view schematically illustrating the constitution of a compound of a Si-containing material and a silane coupling agent and a carbon nanotube according to an example of embodiments. As illustrated in FIG. 2, it is presumed that the isolation of the Si-containing material is more significantly suppressed by the attraction between the amine group or methyl group and the acidic functional group while the benzene ring derived from the silane coupling agent and the benzene ring of the carbon nanotube have a π-π interaction. Accordingly, even if a large volume change occurs in the S000i containing material due to repetition of charge and discharge, disconnection of the conductive path of the negative electrode mixture layer is suppressed, thereby suppressing deterioration of the charge-discharge cycle characteristics.

The acidic functional group may include at least one functional group selected from the group consisting of a carboxyl group, a sulfo group, and a hydroxyl group. The amount of the acidic functional group in the carbon nanotube is, for example, greater than or equal to 0.01 mmol/g and less than or equal to 0.25 mmol/g.

A method of imparting an acidic functional group to a carbon nanotube is not particularly limited, but the acidic functional group may be imparted to the carbon nanotube by, for example, adding the carbon nanotube to a mixed acid of sulfuric acid and nitric acid and reacting the mixed acid for a predetermined time. During the reaction, stirring the mixed acid is desirable. The reaction time is not particularly limited, but is preferably, for example, greater than or equal to 1 hour. The reaction temperature is not particularly limited, but is desirably in the range of greater than or equal to 20° C. and less than or equal to 45° C.

Analysis of the acidic functional group imparted to the carbon nanotube can be performed by TPD-MS (heating evolved gas analysis).

### (TPD-MS Measurement Conditions)

Measuring device: gas chromatograph mass spectrometer (GC unit: 7890 manufactured by Agile Technolories, MS unit: MS-60030BU)
Temperature condition: heating from 100° C. to 1000° C. at 20° C./min and holding for 10 minutes
Carrier gas: helium
Flow rate: 50 mL/min
Measured mass number: m/z=10-600

The fact that an attractive force acts between at least one of an amine group and a methyl group derived from the silane coupling agent and the acidic functional group included in the carbon nanotubes may be confirmed, for example, through observation using a scanning electron microscope (SEM). Specifically, the negative electrode mixture layer scraped from the copper foil is observed using SEM under the following conditions to confirm that the carbon nanotubes are adsorbed on the surface of the Si-containing material.
SEM: JSM7001F manufactured by JEOL
Acceleration voltage: 15 kV
Magnification: 20,000×

Examples of the carbon nanotubes include single-walled carbon nanotubes, double-walled carbon nanotubes, and multi-walled carbon nanotubes. Single-walled carbon nanotubes (SWCNTs) have a carbon nanostructure in which one layer of graphene sheets forms a cylindrical shape, double-walled carbon nanotubes have a carbon nanostructure in which two layers of graphene sheets are concentrically stacked to form a cylindrical shape, and multi-walled carbon nanotubes have a carbon nanostructure in which three or more layers of graphene sheets are concentrically stacked to form a cylindrical shape. Note that a graphene sheet refers to a layer where carbon atoms of sp2 hybrid orbitals forming a graphite crystal are located at the vertices of a regular hexagon. Examples of the shape of carbon nanotubes include, but are not limited to, needle, cylindrical tube, fishbone (fishbone or cup stacked type), tramp (platelet), and coil.

From the viewpoint of further suppressing the deterioration of charge-discharge cycle characteristics, the fiber length of the carbon nanotubes is preferably greater than or equal to 0.5 μm and less than or equal to 500 μm, more preferably greater than or equal to 1 μm and less than or equal to 100 μm, even more preferably greater than or equal to 1 μm and less than or equal to 10 μm, and particularly preferably greater than or equal to 1 μm and less than or equal to 5 μm. The fiber length of the carbon nanotubes can be determined by measuring the lengths of 50 arbitrary carbon nanotubes with a field emission scanning microscope (FE-SEM) and then calculating the arithmetic mean.

The outermost peripheral diameter of the carbon nanotubes is preferably greater than or equal to 0.5 mm and less than or equal to 20 mm, more preferably greater than or equal to 1 mm and less than or equal to 10 mm, and even more preferably greater than or equal to 1 mm and less than or equal to 5 nm, from the viewpoint of, for example, suppressing deterioration of the charge-discharge cycle characteristics. The outermost of the carbon nanotubes can be determined by measuring the outer diameters of 50 arbitrary carbon nanotubes with a field emission scanning microscope (FE-SEM) or a transmission electron microscope (TEM) and then calculating the arithmetic mean.

A content of the carbon nanotubes is preferably greater than or equal to 0.01 mass % and less than or equal to 1 mass %, and more preferably greater than or equal to 0.01 mass % and less than or equal to 0.1 mass % relative to the total mass of the negative electrode active material from the viewpoint of, for example, suppressing deterioration of the charge-discharge cycle characteristics.

The conductive material may include, in addition to carbon nanotubes, a conductive material other than the carbon nanotubes. Examples of the conductive material other than the carbon nanotubes include carbon black (CB) such as acetylene black and Ketjenblack.

The negative electrode mixture layer may further contain a binder. Examples of the binder contained in the negative electrode mixture layer include fluorine-containing resins such as styrene-butadiene rubber (SBR), nitrile-butadiene rubber (NBR), polytetrafluoroethylene (PTFE), and polyvinylidene fluoride (PVDF), polyacrylonitrile (PAN), polyimide resins, acrylic resins, and polyolefin resins, among which SBR and NBR are preferable, and SBR is particularly preferable. These may be used singly or in combination of two or more thereof. A content of the binder in the negative electrode mixture layer is, for example, greater than or equal to 0.5 mass % and less than or equal to 5 mass % relative to the total mass of the negative electrode active material.

The negative electrode mixture layer may further contain a thickener. Examples of the thickener include carboxymethyl cellulose (CMC) or a salt thereof (e.g., CMC-Na), polyacrylic acid (PAA) or a salt thereof (which may be PAA-Na, PAA-K, or a partially neutralized salt), polyethylene oxide (PEO), and polyvinyl alcohol (PVA). These may be used singly or in combination of two or more thereof. A content of the thickener in the negative electrode mixture layer is, for example, greater than or equal to 0.5 mass % and less than or equal to 10 mass % relative to the total mass of the negative electrode active material.

### [Separator]

For the separator 13, a porous sheet having an ion permeation property and an insulation property is used, for example. Specific examples of the porous sheet include a microporous thin film, a woven fabric, and a nonwoven fabric. As a material for the separator 13, an olefin resin such as polyethylene, polypropylene, or a copolymer including at least one of ethylene and propylene, cellulose, or the like is preferable. The separator 13 may have either a single-layered structure or a stacked structure. On a surface of the separator 13, a heat-resistant layer or the like may be formed.

### EXAMPLES

Hereinafter, the present disclosure will be further described with Examples, but the present disclosure is not limited to these Examples.

### Example 1

### [Production of Carbon Nanotube Having Acidic Functional Group]

Carbon nanotubes having a fiber length of 5 μm and an outermost peripheral diameter of 2 nm were placed in a mixed acid of sulfuric acid/nitric acid and subjected to a stirring treatment at 40° C. for 12 hours. After the treatment, the carbon nanotubes were filtered through a glass filter, and the carbon nanotubes remaining on the glass filter were washed with pure water and then naturally dried overnight. When dried samples were analyzed by TPD-MS, all of a sulfo group, a carboxyl group, and a hydroxyl group were confirmed. In Examples, the samples were used as carbon nanotubes having an acidic functional group. Note that the carbon nanotubes having no acidic functional group used in Example 4 and Comparative Example 1 are untreated carbon nanotubes before being placed into the mixed acid.

### [Production of Negative Electrode]

SiO serving as a Si-containing material and graphite were mixed at a mass ratio of 8:92, and the mixture was used as a negative electrode active material. Then, the negative electrode active material, N-phenyl-3-aminopropyltrimethoxysilane, carbon nanotubes having an acidic functional group, sodium carboxymethyl cellulose, and styrene-butadiene rubber were mixed at a mass ratio of 100:0.1:0.02:1.0:1.0. An appropriate amount of water was added to this mixture, followed by kneading to prepare a negative electrode mixture slurry. The negative electrode mixture slurry was applied to both surfaces of a negative electrode current collector made of a copper foil having a thickness of 10 μm, and the coating film was dried. The dried coating film was rolled using a rolling roller to produce a negative electrode in which a negative electrode mixture layer was formed on both surfaces of the negative electrode current collector.

### [Preparation of Electrolyte Liquid]

Ethylene carbonate (EC) and ethyl methyl carbonate (EMC) were mixed at a volume ratio of 30:70. Into the mixed solvent, LiPF₆ was dissolved so that the concentration was 1.4 mol/l, and 2 mass % of vinylene carbonate (VC) was dissolved relative to the total amount of the electrolyte liquid. This mixture was used as an electrolyte liquid of Examples.

### [Production of Secondary Battery]

A separator made of a polyethylene microporous film was disposed between the metal Li and the negative electrode, which were wound and then formed into a flat shape to produce a wound electrode assembly. After the electrode assembly and the electrolyte liquid were housed in an outer package composed of an aluminum laminate, the interior of the outer package was depressurized to impregnate the separator with the electrolyte liquid, and then the opening portion of the outer package was sealed to produce a secondary battery.

### Example 2

A secondary battery was produced in the same manner as in Example 1 except that, in the production of the negative electrode, p-styryltrimethoxysilane was used instead of N-phenyl-3-aminopropyltrimethoxysilane.

### Example 3

A secondary battery was produced in the same manner as in Example 1 except that, in the production of the negative electrode, the amount of N-phenyl-3-aminopropyltrimethoxysilane added was changed to 0.4 mass % relative to the total mass of the negative electrode active material.

### Example 4

A secondary battery was produced in the same manner as in Example 1 except that, in the production of the negative electrode, the amount of N-phenyl-3-aminopropyltrimethoxysilane added was changed to 0.4 mass % relative to the total mass of the negative electrode active material, and carbon nanotubes having no acidic functional groups were added instead of the carbon nanotubes having an acidic functional group.

### Example 5

A secondary battery was produced in the same manner as in Example 1 except that, in the production of the negative electrode, the amount of N-phenyl-3-aminopropyltrimethoxysilane added was changed to 0.8 mass % relative to the total mass of the negative electrode active material.

### Comparative Example 1

A secondary battery was produced in the same manner as in Example 1 except that, in the production of the negative electrode, N-phenyl-3-aminopropyltrimethoxysilane was not added, while carbon nanotubes having no acidic functional group were added instead of the carbon nanotubes having an acidic functional group.

### Comparative Example 2

A secondary battery was produced in the same manner as in Example 1 except that, in the production of the negative electrode, N-phenyl-3-aminopropyltrimethoxysilane was not added.

### [Evaluation of Capacity Retention]

Under an environment at a temperature of 25° C., each of the secondary batteries of Examples and Comparative Examples was charged at a constant current (current: 0.1 It, cut-off voltage: 0.005 V) and then charged at a constant voltage (voltage: 0.005 V, cut-off current: 0.01 It). Thereafter, the secondary batteries were discharged at a constant current (current: 0.1 It, cut-off voltage: 1.5 V). This charge-discharge cycle was regarded as one cycle and performed with 10 cycles. The capacity retention of the secondary batteries of each Example and each Comparative Example during charge-discharge cycles were calculated by the following equations. The higher the capacity retention, the more the deterioration of the charge-discharge cycle characteristics is suppressed.

$$Capacity retention ( \% ) = ( discharge capacity at 10 th cycle / discharge capacity at 1 st cycle )$$

### [Evaluation of Viscosity of Slurry]

The viscosity of the negative electrode mixture slurries prepared in each Example and each Comparative Example was measured with a viscosity measuring device under the following conditions, and from the measurement results of conditions (1) and (2), the influence on the coating properties was judged from the viscosity. A case where the coating film had no problem and could be applied in a good state was evaluated as “Good”, and a case where the coating film had no problem but could not be applied in a good state when the viscosity became higher than that was evaluated as “Acceptable”.

Viscosity measuring device: TV-22 viscometer manufactured by Toki Sangyo Co., Ltd.

Rotational speed and measurement time: condition (1) rotational speed of 2 rpm for 60 seconds; condition (2) rotational speed of 20 rm for 60 seconds

Table 1 summarizes the evaluation results of Examples and Comparative Examples, provided that the capacity retention shows the results of other Examples and Comparative Examples with the result of Comparative Example 1 as the standard (100%).

TABLE 1

| | | | CNT | | |
|---|---|---|---|---|---|
| | Silane coupling agent | | Acidic | | |
| | Amine group | Addition | func- | | Slurry |
| | or methyl | amount | tional | Capacity | viscos- |
| | group | [%] | group | retention | ity |
| Example1 | Amine group | 0.1 | Present | 100.9 | Good |
| Example2 | Methyl group | 0.1 | Present | 100.6 | Good |
| Example3 | Amine group | 0.4 | Present | 100.6 | Good |
| Example4 | Amine group | 0.4 | None | 100.4 | Good |
| Example5 | Amine group | 0.8 | Present | 100.6 | Accept- |
| | | | | | able |
| Comparative | None | — | None | 100.0 | Good |
| Example1 | | | | | |
| Comparative | None | — | Present | 100.2 | Good |
| Example2 | | | | | |

All of Examples 1 to 5 exhibited higher capacity retention than Comparative Examples 1 and 2. As can be seen from this result, the deterioration of the charge-discharge cycle characteristics can be suppressed when the negative electrode mixture layer contains a compound of a Si-containing material and a silane coupling agent having a predetermined structure, and carbon nanotubes. Note that in Example 5, the evaluation result of the slurry viscosity was acceptable, which is considered that the formation of the positive electrode mixture layer becomes difficult when the amount of the coupling agent added is further increased.

The present disclosure will be further described with the following embodiments.

### Constitution 1:

A negative electrode for a secondary battery, comprising:
a negative electrode current collector; and
a negative electrode mixture layer formed on a surface of the negative electrode current collector, wherein
the negative electrode mixture layer contains a compound of a Si-containing material serving as a negative electrode active material and a silane coupling agent, and carbon nanotubes, and
the silane coupling agent has at least one of an amine group and a methyl group, and a phenyl group.

### Constitution 2:

The negative electrode for a secondary battery according to Constitution 1, wherein the carbon nanotubes have an acidic functional group.

### Constitution 3:

The negative electrode for a secondary battery according to Constitution 2, wherein the acidic functional group includes at least one functional group selected from the group consisting of a carboxyl group, a sulfo group, and a hydroxyl group.

### Constitution 4:

The negative electrode for a secondary battery according to Constitution 2 or 3, wherein
the compound is formed by covalent bonding between a silanol group included in the silane coupling agent and a hydroxyl group on a surface of the Si-containing material,
a benzene ring derived from the silane coupling agent in the compound and a benzene ring of the carbon nanotubes have a π-π interaction, and
an attractive force acts between at least one of an amine group and a methyl group derived from the silane coupling agent in the compound and the acidic functional group included in the carbon nanotubes.

### Constitution 5:

The negative electrode for a secondary battery according to any one of Constitutions 1 to 4, wherein the carbon nanotubes have a fiber length of greater than or equal to 0.5 μm and less than or equal to 500 μm.

### Constitution 6:

The negative electrode for a secondary battery according to any one of Constitutions 1 to 5, wherein the carbon nanotubes have an outermost peripheral diameter of greater than or equal to 0.5 nm and less than or equal to 20 nm.

### Constitution 7:

The negative electrode for a secondary battery according to any one of Constitutions 1 to 6, wherein
the negative electrode active material includes a carbon material, and
in the negative electrode mixture layer, a content of the carbon nanotubes is greater than or equal to 0.01 mass % and less than or equal to 1.0 mass % relative to a total mass of the negative electrode active material.

### Constitution 8:

The negative electrode for a secondary battery according to any one of Constitutions 1 to 7, wherein an amount of the silane coupling agent added is greater than or equal to 0.01 mass % and less than or equal to 0.8 mass % relative to a total mass of the negative electrode active material.

### Constitution 9:

A secondary battery, comprising:
the negative electrode for a secondary battery according to any one of Constitutions 1 to 8.

### REFERENCE SIGNS LIST

10 Secondary battery, 11 Positive electrode, 12 Negative electrode, 13 Separator, 14 Electrode assembly, 15 Battery case, 16 Case body, 17 Sealing assembly, 18, 19 Insulating plate, 20 Positive electrode lead, 21 Negative electrode lead, 22 Projecting portion, 23 Filter, 24 Lower vent member, 25 Insulating member, 26 Upper vent member, 27 Cap, 28 Gasket

1. A negative electrode for a secondary battery, comprising:
a negative electrode current collector; and
a negative electrode mixture layer formed on a surface of the negative electrode current collector, wherein
the negative electrode mixture layer contains a compound of a Si-containing material serving as a negative electrode active material and a silane coupling agent, and carbon nanotubes, and
the silane coupling agent has at least one of an amine group and a methyl group, and a phenyl group.

2. The negative electrode for a secondary battery according to claim 1, wherein the carbon nanotubes have an acidic functional group.

3. The negative electrode for a secondary battery according to claim 2, wherein the acidic functional group includes at least one functional group selected from the group consisting of a carboxyl group, a sulfo group, and a hydroxyl group.

4. The negative electrode for a secondary battery according to claim 2, wherein
the compound is formed by covalent bonding between a silanol group included in the silane coupling agent and a hydroxyl group on a surface of the Si-containing material,
a benzene ring derived from the silane coupling agent in the compound and a benzene ring of the carbon nanotubes have a π-π interaction, and
an attractive force acts between at least one of an amine group and a methyl group derived from the silane coupling agent in the compound and the acidic functional group included in the carbon nanotubes.

5. The negative electrode for a secondary battery according to claim 1, wherein the carbon nanotubes have a fiber length of greater than or equal to 0.5 μm and less than or equal to 500 μm.

6. The negative electrode for a secondary battery according to claim 1, wherein the carbon nanotubes have an outermost peripheral diameter of greater than or equal to 0.5 mm and less than or equal to 20 nm.

7. The negative electrode for a secondary battery according to claim 1, wherein
the negative electrode active material includes a carbon material, and
in the negative electrode mixture layer, a content of the carbon nanotubes is greater than or equal to 0.01 mass % and less than or equal to 1.0 mass % relative to a total mass of the negative electrode active material.

8. The negative electrode for a secondary battery according to claim 1, wherein an amount of the silane coupling agent added is greater than or equal to 0.01 mass % and less than or equal to 0.8 mass % relative to a total mass of the negative electrode active material.

9. A secondary battery, comprising:
the negative electrode for a secondary battery according to claim 1.
